(19) United States
(12) Patent Application Publication
(10) Pub. No.: US 2013/0299515 A1
(43) Pub. Date: Nov. 14, 2013

(54) Multi-Chamber Container

(71) Applicant: Christoph Geiberger, Konigswinter (DE)

(72) Inventor: Christoph Geiberger, Konigswinter (DE)

(73) Assignee: Scapa Holding GmbH, Eschborn (DE)

(21) Appl. No.: 13/876,314

(22) PCT Filed: Sep. 28, 2011
(86) PCT No.: PCT/EP2011/004849

§ 371 Date: May 9, 2013

(30) Foreign Application Priority Data
Oct. 1, 2010 (DE) 202010013855.8

(51) Int. Cl. B05B 11/00

(52) U.S. Cl. CPC B05B 11/0078; B05B 11/3052
USPC 222/136; 222/391; 222/390

(57) ABSTRACT

Disclosed is a multi-chamber container with a container housing with at least two chambers arranged one upon the other for receiving product components, and a dosing element which discharges the product components by means of pistons allocated to the chambers and movable along the longitudinal axis of the container. The present invention provides a multi-chamber container which discharges the product components from the chambers in an improved manner. The multi-chamber container according to the present invention has at least one piston which is movably engaged with an element extending along the longitudinal axis of the container.

The present invention relates in particular to a multi-chamber container with a container housing with at least two chambers disposed one upon the other for receiving product components. The multi-chamber container furthermore comprises a dosing element which discharges the product components by means of pistons allocated to the chambers and displaceable along the longitudinal axis of the container.

A generic multi-chamber container, which is also referred to as multi-chamber container because of at least two chambers disposed one upon the other, is known, for example, from DE 20 2007 004 662 U1.

In the known multi-chamber container, a device is provided for generating a pressure differential that discharges the first and/or the second product component out of the respective chamber. The device, which is realized here as a pump, generates an overpressure in the chamber downstream of the pump when it is actuated. This overpressure is forwarded to a following downstream chamber, so that the contained product component is discharged from both chambers. After the product components have been withdrawn, the pump is restored to its original position by a spring. During this restoring motion, a vacuum is formed in both chambers, moving the pistons of the chambers towards the dosing head. By means of a rotatably mounted dosing element, it is possible to open or close the discharge openings of the chambers corresponding to the mixing ratio, so that the ratio of the different discharged product components can be varied.

It is a disadvantage in prior art that the motion of the pistons induced by vacuum deteriorates as the viscosity of the product components increases, and as of a certain degree of viscosity, no more motion is generated at all. Moreover, in a multi-chamber container with several chambers, the transmissibility of the overpressure/vacuum from one chamber to the next chamber can also decrease.

It is an object of the present invention to provide a multi-chamber container which discharges the product components out of the chambers in an improved manner. A multi-chamber container in the sense of this invention is defined as a container with at least two, optionally also three or more separate chambers for receiving different product components each.

To achieve this object, the present invention suggests a multi-chamber container with the features of claim 1. The latter differs from generic prior art in that at least one piston is displaceably engaged with an element extending along the longitudinal axis of the container.

The invention permits to also discharge product components of very high viscosity. It is also possible to achieve a more precise dosing of the individual product components by the direct engagement of the element extending along the longitudinal axis of the container.

An engagement in the sense of the invention is in particular defined as an arrangement between the piston and the element which permits to transmit forces from the element to the piston. The engagement is here preferably accomplished with a positive and/or non-positive fit. Particularly preferred, a positive connection in the form of a thread or the like is employed. Engagement devices between the piston and the longitudinal axis of the container causing a certain positive fit due to wedging are also conceivable, where these in any case lead to the piston getting stuck with the element extending in the direction of the longitudinal axis of the container, so that only a relative motion of the two elements in one direction is possible. In particular, devices can be employed which cut into the material of the cooperation partner of engagement to position both elements in a predetermined manner relative to each other.

The present invention offers the possibility of displacing the pistons disposed in the multi-chamber container to discharge the different product components. The displacement of all pistons is here preferably done by means of the element extending along the axis of the container. This element has a clearly larger spatial extension in the longitudinal than in the transverse direction. Furthermore, the element comprises sufficient dimensional and material properties to absorb the tensile and/or compressive forces occurring in the multi-chamber container to be able to discharge the product components.

A chamber in the sense of the invention is optionally also defined as a variable space which is suited, per se or by accommodating a bag, for receiving the product quantity to be stored in the multi-chamber container and also to be discharged by the latter. A chamber is here in particular defined as a receiving space suited for storing a sufficient quantity of the product component, so that the product can be withdrawn repeatedly. The stored volume is normally large compared to the volume discharged during dosing, i. e. the actuation of the dosing element.

A dosing element in the sense of the invention is defined as an element which discharges the product components from the chambers upon actuation. The dosing element is preferably disposed at the head of the multi-chamber container, but it can, for example, also be embodied at the bottom of the multi-chamber container. Preferably, the dosing element additionally comprises the discharge openings of the different chambers. Here, it is also possible to mix individual product components in the dosing element and to discharge them as a mixture. The dosing element can be embodied, for example, according to the disclosure of DE 20 2007 004 662 U1 by the present applicant, the disclosure of which being included in this application by reference. For example, the dosing element can be provided to be rotatable to completely or partially close one or two discharge openings of the channels leading to the different chambers to thus vary the mixing ratio of the individual discharged product components.

In a preferred embodiment of the multi-chamber container, an engaged engagement region is formed by a spring washer. This spring washer here usually cooperates with the outer circumference of the piston and cuts, during the relative motion of the piston along the longitudinal axis of the container, into the respective element of the multi-chamber container extending in parallel thereto to keep the piston engaged with this element. The spring washer accordingly cooperates with the elements extending in the direction of the longitudinal axis of the container, such that a relative motion in a direction between the element and the piston is possible, whereas in a reversed relative motion, the spring washer interlocks with the element and prevents a relative motion.

The spring washer is preferably provided concentrically to the longitudinal axis of the container in the engagement region of at least one piston of the multi-chamber container and is preferably fixed during the manufacture of the piston by injection molding around the spring washer with plastics. The spring washer can be a spring washer of metal or plastics. Preferably, the spring washer is inserted into an injection mold as an insert and during the manufacture of the piston sealed into it by molding around with plastics in the course of injection molding. A push rod preferably projects through the spring washer and cooperates with the spring washer for transmitting forces with the piston. A push rod in the sense of the invention is in particular defined as a rod which performs, by applying a pressing force in the longitudinal direction of the rod, a displacement in the direction of the longitudinal axis of the multi-chamber container. The push rod is preferably made of plastics, while other materials, e. g. metal, can also be employed. The surface of the push rod can be either smooth or provided with depressions, for example in the form of a serrated profile, for a locking engagement of the spring washer with the push rod. The spring washer is preferably bent in the region of the inner diameter in the pushing direction of the push rod. By this, an essentially translatory motion of the push rod relative to the piston in the pushing direction is admitted by the spring washer. In a motion opposite to the pushing direction of the push rod, the spring washer blocks the motion of the push rod, so that the push rod is positively connected with the piston and the piston is entrained via the push rod.

The above-described positive fit is achieved by the spring washer either engaging, for example, the serrated profile or cutting into the surface when the surface of the push rod is smooth. In a further embodiment of the push rod, the push rod can comprise an outer push rod and at least one inner push rod. Preferably, these push rods are coupled in the longitudinal direction, so that all push rods cover the same pushing paths. However, it is also possible to arrange the outer push rod with the at least one inner push rod to be displaceable with respect to each other. This permits to move the pistons corresponding to the push rods with different path lengths due to different deflections of the push rods.

For all chambers of a multi-chamber container to communicate with the discharge openings, the push rods which penetrate a chamber and project into the next chamber are each embodied as rising pipes. In case of interpenetrating push rods with different diameters, a ring channel is usually formed between the outer push rod and the inner push rod which acts as a rising pipe.

In an alternative embodiment of the multi-chamber container, the element is formed by a spindle. A spindle in the sense of the invention is defined as a component which permits a relative rotation with respect to a component engaged with the spindle. This spindle is rotatably mounted with respect to the container housing or the piston, respectively. The spindle is formed of plastics or metal and preferably has an external thread.

The spindle is driven from the head or base side by a drive with a drive sleeve which drives a tappet via a guide bevel, the tappet comprising a toothing formed concentrically to the axis of revolution, the toothing cooperating with a counter-toothing formed concentrically to the axis of revolution. Via this engagement, thus the rotational or swiveling motion of the tappet can be transmitted to the spindle.

In another embodiment of the spindle, an additional toothing formed concentrically to the axis of revolution is provided which engages a counter-toothing in such a way that a reversed rotational motion of the spindle is blocked. Embodiments of a reversed rotation lock in which one or several flexible tongues engage a toothing are also possible. The drive of the piston in the multi-chamber container according to the invention is preferably accomplished such that, after product components have been discharged from the chambers, a return suction effect occurs which draws the product component from the discharge opening back into the interior of the container, so that the product component does not stay at the discharge opening or inadvertently exits from the latter. The return suction effect usually occurs due to the overpressure in the chambers in any case when the devices preventing the piston from jumping back into its original position are designed correspondingly. Thus, a certain clearance in the above mentioned reversed rotation lock or the spring washer already described above can permit such a return suction effect. In the preferably provided drive with a drive sleeve with a toothing and a counter-toothing cooperating with the spindle, too, a corresponding clearance can be provided which permits a certain restoration of the piston for drawing back the product component into the multi-chamber container. This return suction effect can also be effected by adequately designing the toothing or counter-toothing.

The spindle can comprise, for example, an upper and at least one lower spindle. The spindle can also comprise an outer spindle and at least one inner spindle. The latter arrangement has the advantage that a separate drive can be allocated to each spindle. These drives can then be designed such that these different spindles are driven at different angular velocities.

In one preferred embodiment, the outer spindle is connected with the at least one inner spindle, or the upper spindle is connected with the at least one lower spindle, respectively, in a torque-proof manner. Thereby, a rotary motion can be equally transmitted to all spindles.

In the embodiment with the spindle, the spindle which penetrates one chamber and projects into the next chamber can be embodied as a rising pipe, as in the embodiment with the push rod. For receiving the product component from the corresponding chamber, the rising pipe is opened on the end side. In an embodiment where one spindle penetrates several chambers, inlet openings can be embodied at the periphery of the spindle.

For the engagement with the piston, the spindle preferably has a thread which cooperates with the thread of the pistons. Alternatives are also possible, where the spindle has a smooth surface and the pistons comprise self-cutting elements, for example of metal, which cut into and along the spindle with a positive fit, for example in the form of a thread. These elements are preferably fixed during the manufacture of the piston by surrounding them with the plastic that forms the piston by means of injection molding, just like the spring washer.

Relative motions between the pistons at equal angular velocities of the spindles are possible when the spindles allocated to the individual pistons are embodied with different thread pitches, as is suggested according to a preferred further development of the present invention. In this connection, the use of left-handed and right-handed threads is also conceivable, e. g. to displace the pistons into opposite directions. For this embodiment, a spindle whose threads run in opposite directions would, for example, also be possible. Embodiments are also possible where in one spindle, segments with different thread pitches are embodied.

In another preferred embodiment of the invention, the outer spindle has an internal thread. The inner spindle, which is held at an end side in a piston in a torque-proof manner, will cooperate with this internal thread. By rotation of the outer spindle, thus the outer spindle and the inner spindle can be rotated with respect to each other. An embodiment where the outer spindle is held at an end side in a piston in a torque-proof manner and the inner spindle is driven by a drive is also possible.

Further details of the present invention can be taken from the following description of several embodiments in connection with the drawing. In this drawing:

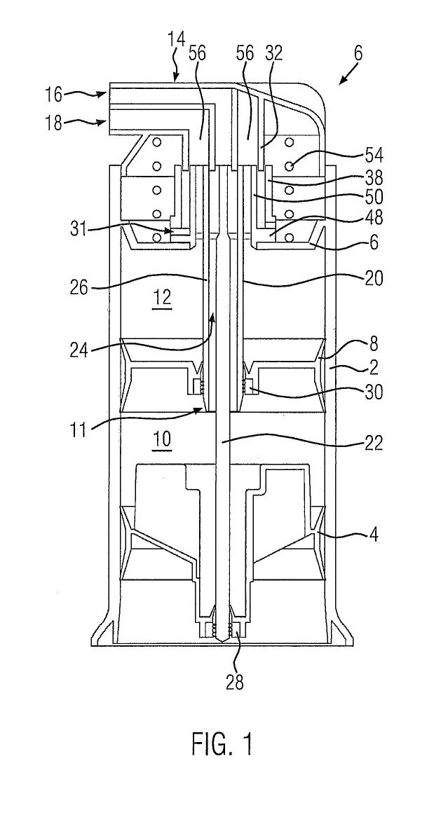

FIG. 1 shows a longitudinal sectional view of an embodiment of the multi-chamber container according to the invention,

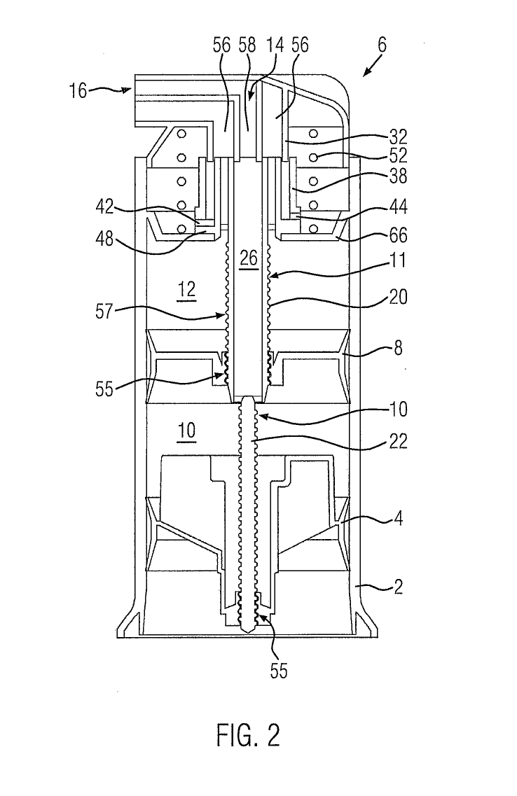

FIG. 2 shows a longitudinal sectional view of a second embodiment of the multi-chamber container according to the invention,

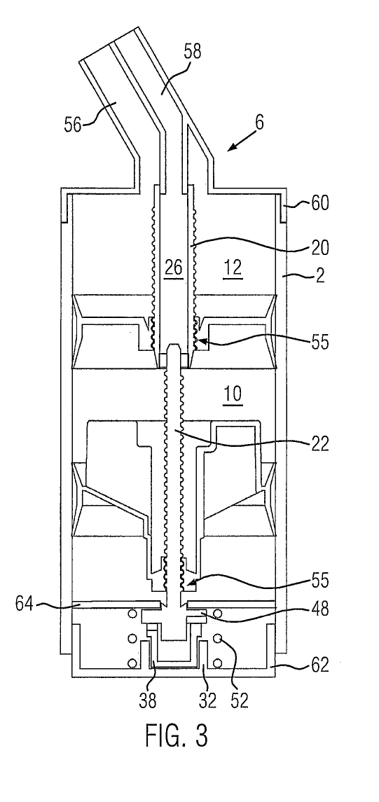

FIG. 3 shows a longitudinal sectional view of a third embodiment of the multi-chamber container according to the invention,

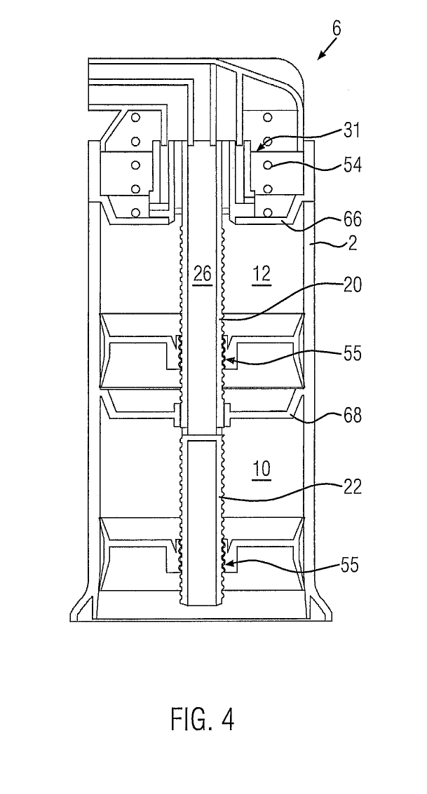

FIG. 4 shows a longitudinal sectional view of a fourth embodiment of the multi-chamber container according to the invention,

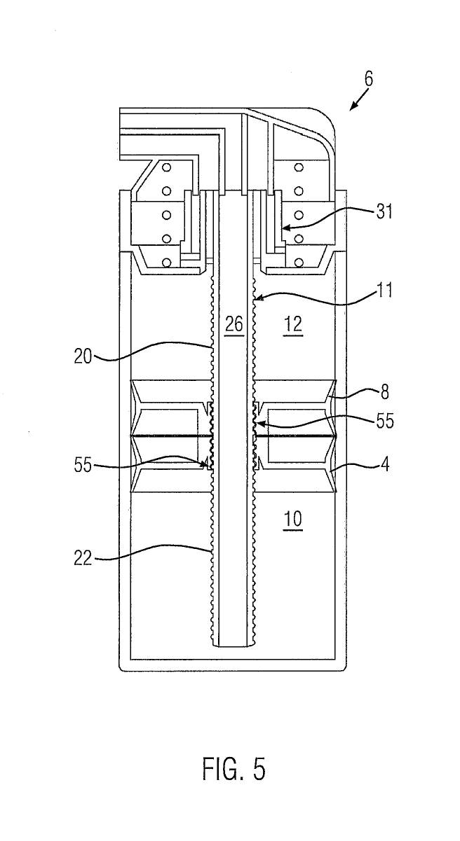

FIG. 5 shows a longitudinal sectional view of a fifth embodiment of the multi-chamber container according to the invention,

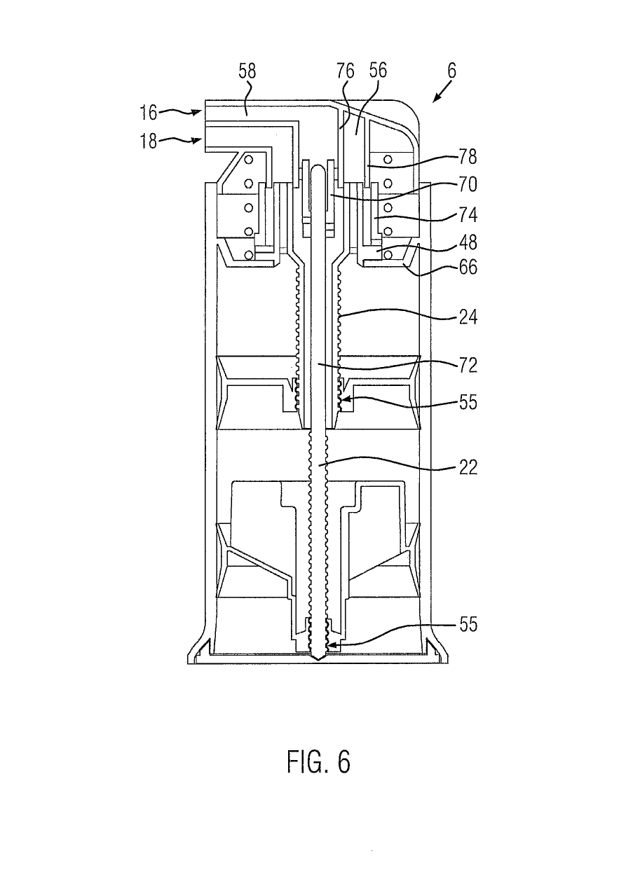

FIG. 6 shows a longitudinal sectional view of sixth embodiment of the multi-chamber container according to the invention,

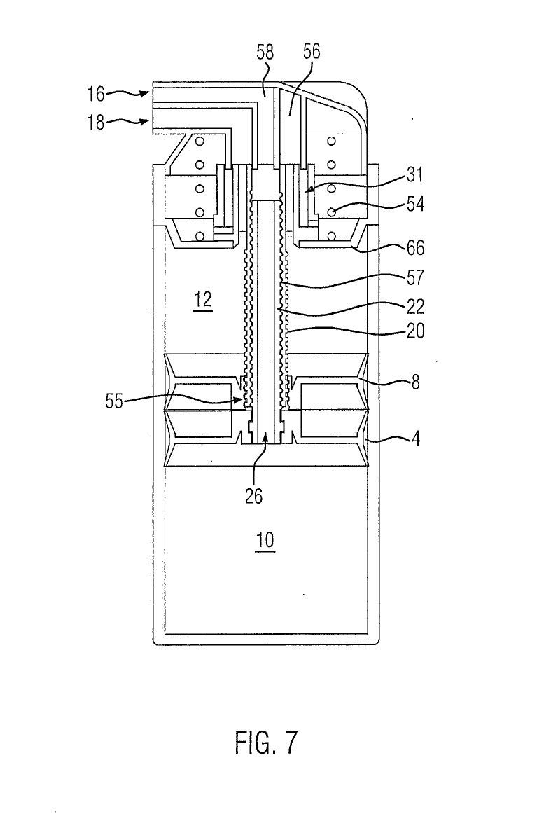

FIG. 7 shows a longitudinal sectional view of a seventh embodiment of the multi-chamber container according to the invention,

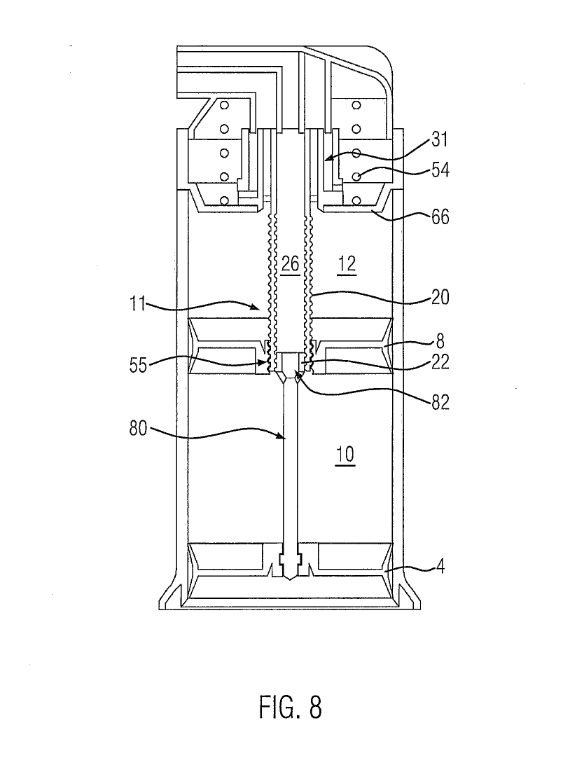

FIG. 8 shows a longitudinal sectional view of an eighth embodiment of the multi-chamber container according to the invention,

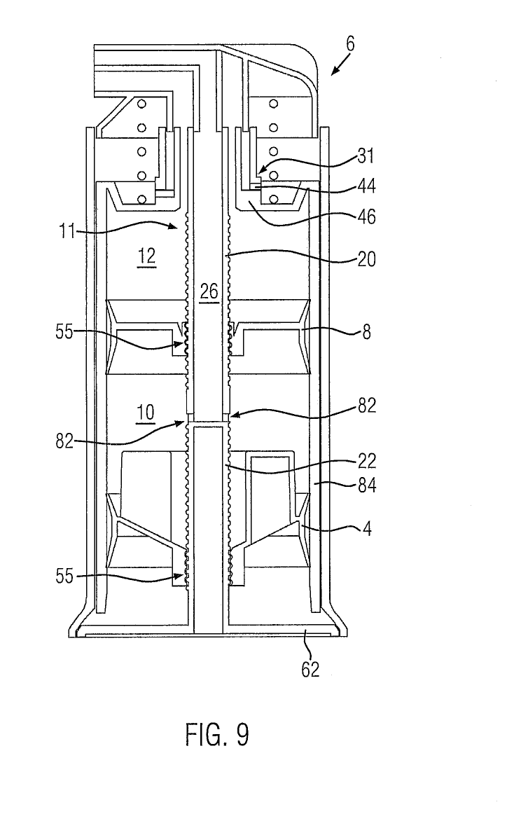

FIG. 9 shows a longitudinal sectional view of a ninth embodiment of the multi-chamber container according to the invention,

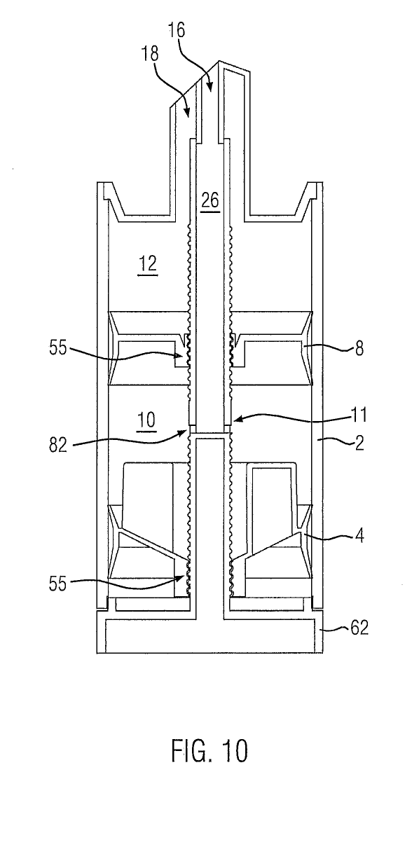

FIG. 10 shows a longitudinal sectional view of a tenth embodiment of the multi-chamber container according to the invention,

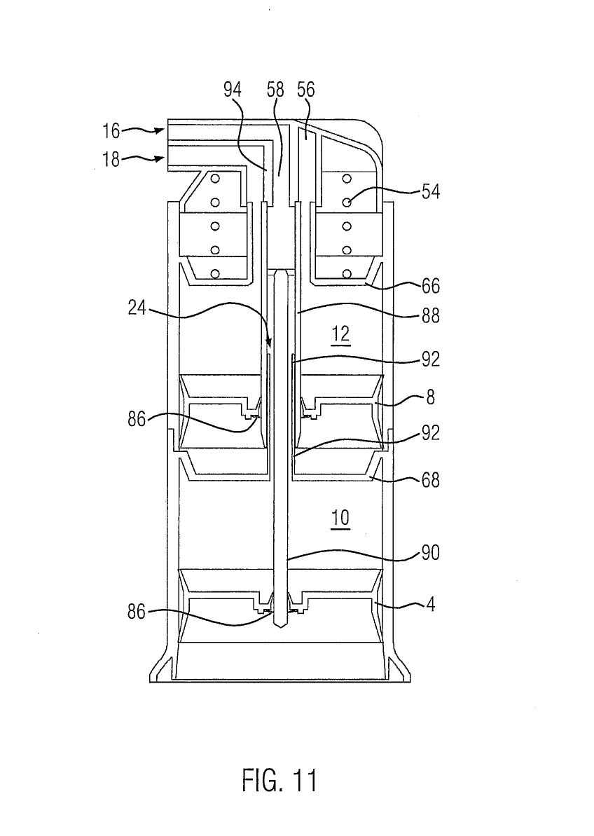

FIG. 11 shows a longitudinal sectional view of an eleventh embodiment of the multi-chamber container according to the invention,

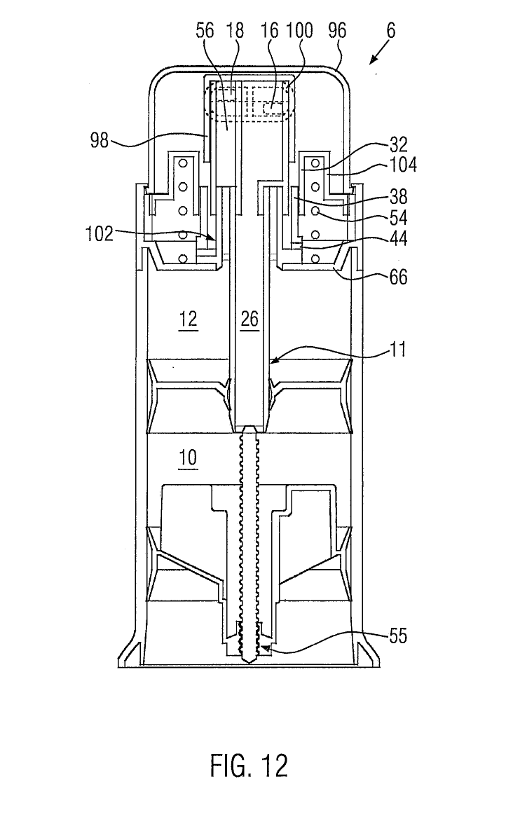

FIG. 12 shows a longitudinal sectional view of a twelfth embodiment of the multi-chamber container according to the invention,

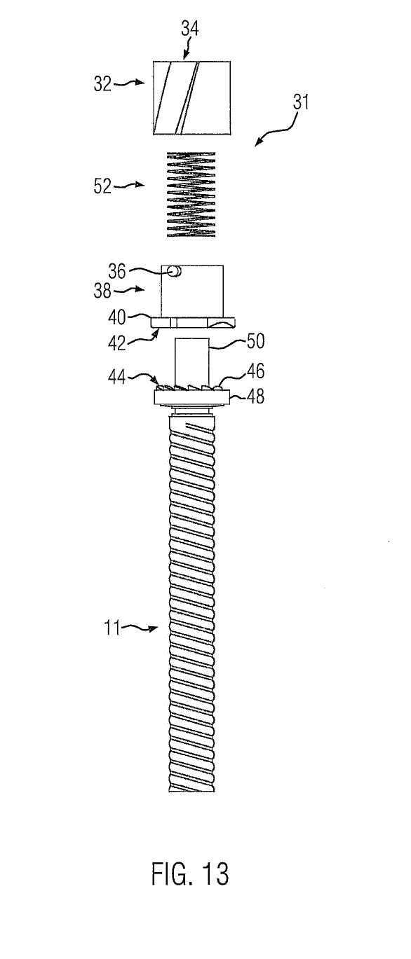

FIG. 13 shows a side view in an exploded view of the principal design of a spindle drive, and

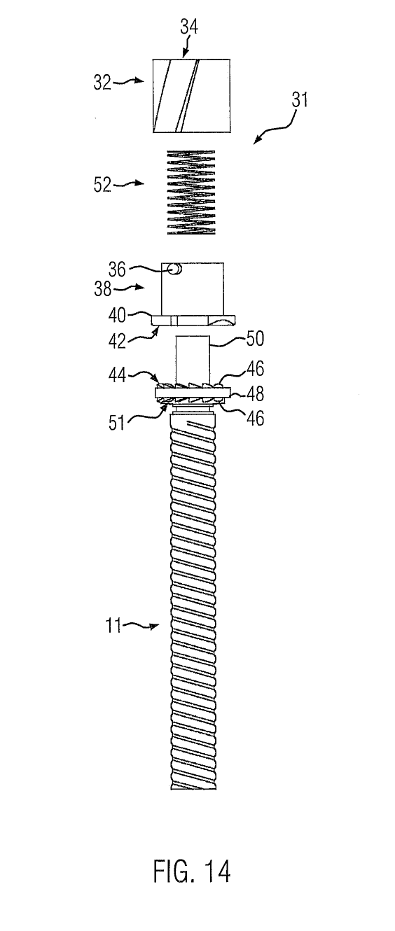

FIG. 14 shows a side view in an exploded view of the principal design of another spindle drive.

FIG. 1 shows a longitudinal sectional view for the first embodiment of a multi-chamber container with a container housing 2 which is terminated at the bottom side by a lower piston 4 movably received in the container housing 2, and at the upper side by a housing head 6. Between the housing head 6 and the lower piston 4, an upper piston 8 is movably arranged in the multi-chamber container and divides the multi-chamber container into a lower chamber 10 and an upper chamber 12.

The housing head 6 comprises and embodies a dosing element 14 having two discharge openings 16, 18 which are arranged one upon the other and communicate with the two chambers 10, 12, so that the two product components are separately discharged from the chambers 10, 12.

The pistons 4, 8 comprise sealing lips in a manner known per se which cooperate with the inner periphery of the container housing 2. In addition, the pistons 4, 8 are engaged with a spindle 11. The spindle 11 comprises an outer spindle 20 for engagement with the upper piston 8 and an inner spindle 22 for engagement with the lower piston 4. The outer spindle 20, which is connected with the inner spindle 22 in a torque-proof manner, is additionally designed such that it penetrates the upper chamber 12 and that a ring channel 24 is formed between the outer spindle 20 and the inner spindle 22, so that the outer spindle 20 surrounds an annular rising pipe 26 for the product component of the lower chamber 10. The engagement of the piston 4, 8 is accomplished by self-cutting elements 28, 30 of metal or plastics which are fixed in the pistons 4, 8 and shaped such that they cut a thread into the smooth outer periphery of the spindle 11.

A drive 31 is provided for the spindle 11 which converts, upon actuation of the dosing element 14, the thus effected translatory motion of the dosing element 14 into a rotational motion of the spindle 11. In FIG. 13, this drive is represented for an embodiment of a spindle 11 as an alternative to the embodiment according to FIG. 1. For the following description, only the details of the drive are relevant.

The drive 31 has a drive sleeve 32 which is usually fixed or added to the housing head 6 in a torque-proof manner. The drive sleeve 32 comprises guide bevels 34 which are provided on opposite side walls of the drive sleeve 32. The guide bevels 34 are embodied as grooves at the drive sleeve 32. The guide bevels 34 cooperate with tappet cams 36 which are embodied at a tappet 38 which is received in the housing head 6 to be rotatable and at least slightly movable in the longitudinal direction of the container. This tappet 38 has a tappet flange 40 at its front side facing the spindle 11 whose free annular face is formed as a toothing 42.

The spindle 11 bears a counter-toothing 44 to this toothing 42. This counter-toothing 44 is embodied at an annular face 46 of a spindle flange 48 over which an axial projection 50 integrally formed at the spindle 11 projects. Via this axial projection 50, the tappet 38 is rotatably mounted, but can be displaced in the longitudinal direction of the spindle 11.

The exploded view of the spindle drive in FIG. 13 furthermore shows a pressure spring 52 of the drive 31 which urges the drive sleeve 32 towards the spindle head 6, i. e. against the gravity of earth away from the tappet 38.

The spindle drive shown in FIG. 14 essentially corresponds to the spindle drive of FIG. 13 and only differs by an additional counter-toothing 51 on the annular face 46 of the spindle flange 48 opposed to the counter-toothing 44. This counter-toothing 51 cooperates with a further toothing (not shown), such that a reversed rotational motion is blocked.

The drive 31 shown in FIG. 13 approximately functions like the drive of a ball pen. Upon actuation of the dosing head 6, the drive sleeve 32 is pressed downwards in the axial direction, i. e. in the direction towards the spindle 11. This compressive force is transmitted via the pressure spring 52 to the tappet 38, so that the toothing 42 is pressed against the counter-toothing 44. Simultaneously, the positive engagement of the tappet cams 36 in the groove-like guide bevels 34 leads to a pivoting motion of the tappet 38 relative to the drive sleeve 32 which is held in a torque-proof manner in the present case. This rotational motion of the tappet 38 is transmitted to the spindle 11 via the serrated toothing which is formed at the toothing 42 and the counter-toothing 44. When the housing head 6 is released, a readjusting spring, which supports itself at the container on the one hand and at the housing head 6 on the other hand and is designated with reference numeral 54 in FIG. 1, causes the housing head 6 to be lifted. Thereby, the drive sleeve 32 is relieved. The pressure or readjusting spring 52/54 accordingly presses the drive sleeve 32 upwards in the longitudinal direction of the container housing 2. As here no axial resistance acts on the drive sleeve 32, the teeth of the toothing 42 and the counter-toothing 44 are disengaged. The tappet 38 can follow the forced rotary motion without the spindle 11 being rotated. Not before the housing head 6 is actuated again is the spindle 11 subjected again to a rotary motion in the manner described above.

It is evident that this rotary motion of the spindle results in a rise of the pistons 4, 8 which are engaged with the spindle 11 via a thread 55.

In the embodiment shown in FIG. 1, the spindle flange 48 is connected with the outer spindle 20 via webs in a torque-proof manner. In the shown embodiment, the drive sleeve 32 is integrally formed at the dosing element 14 of the housing head. Here, the drive sleeve also embodies the outer limiting walls of channels 56 to the upper chamber 12 which are connected to each other in the upper region of the housing head 6 and lead to the discharge opening 18. In all embodiments of a drive according to FIG. 13, the pressure spring 52 is moreover formed by the readjusting spring 54 which restores the housing head 6 or a drive element of the multi-chamber container, respectively, into the original position.

Below, some modifications of the embodiment shown in FIG. 1 will be illustrated with reference to the drawing. Identical components are designated with identical reference numerals of the above-mentioned embodiment.

The embodiment shown in FIG. 2 includes the essential difference that there, the spindle 11 is provided with a thread 57 with a thread pitch, so that the spindle 11 is a threaded spindle from the beginning and does not only become one by the action of the self-cutting elements 28, 30, as in the embodiment according to FIG. 1. The embodiment shown in FIG. 2 also has an outer spindle 20 acting as a rising pipe 26 and penetrating the upper chamber 12, so that the product component displaced from the lower chamber 10 can reach the housing head 6 and the discharge opening 16. The inner spindle 22 is held in a torque-proof manner at the lower end of the outer spindle 20.

The embodiment shown in FIG. 3 represents a modification of the embodiment shown in FIG. 2. In this embodiment, however, the housing head 6 is connected with the container housing 2 as a fixed housing element and only comprises the channels 56 and 58 for the product components. As in the embodiment shown in FIG. 2, the inner spindle 22 is realized as lower spindle which is provided in the longitudinal direction of the container below the outer spindle 20 which insofar forms the upper spindle. Consequently, here, too, the upper spindle 20 forms the rising pipe 26 which leads to the channel 58.

In the embodiment shown in FIG. 3, the drive is effected via a housing bottom 62 which can be pressed into the container housing 2 against the pressure of the pressure spring 52. This housing bottom 62 integrally forms the drive sleeve 32 which cooperates with the tappet 38. The introduction of force is accomplished via the spindle flange 48 formed at the end side of the lower spindle 22 and resting against a ring disk 64 integrally formed at the container housing 2 and being centered in a bore left open therein. The ring disk 64 also functions as abutment for the pressure or readjusting spring 52, respectively.

The embodiments shown in FIGS. 1 to 3 each have a lower chamber 10 which is limited at the top by the upper piston 8, so that with the same rise of the spindle 11, i. e. the same axial displacement of the upper piston 8 and the lower piston 4, at a predetermined angle of rotation of the spindle 11, the volume of the lower chamber 10 does not become smaller. By the rise of the outer spindle 20 and the inner spindle 22, or the lower spindle 22 and the upper spindle 20, respectively, or the respective embodiment of the self-cutting elements 28, 30, the mixing ratio can be adjusted, so that a predetermined volume of the product component contained in the respective chambers 10, 12 is discharged from both chambers 10, 12 at a predetermined angle of rotation of the spindle 11.

This is different with the embodiment shown in FIG. 4 where the respective chambers 10, 12 are each separately limited on one side by partitions on the container side, the upper partition being designated with reference numeral 66, and the lower partition being designated with reference numeral 68. The lower partition 68 simultaneously functions as bearing for the upper spindle 20. The latter is also embodied as rising pipe 26. The region located above the upper partition 66 of the embodiment shown in FIG. 4 corresponds to that shown in FIGS. 1 and 2. Even when the rise of the respective thread pitches of the upper spindle 20 and the lower spindle 22 is equal, product components are discharged in the embodiment shown in FIG. 4.

The embodiment shown in FIG. 5 represents a modification of the embodiment shown in FIG. 4. In this embodiment, the respective chambers 10, 12 are compressed against a fixed housing wall when the pistons 4, 8 are moving. In the embodiment shown in FIG. 5, the container housing 2 is designed like a pot and closed at the bottom side. The spindle 11 is embodied as a unitary spindle, where between the pistons 4, 8 shown in their original positions in FIG. 5, the thread pitch changes from a left-handed thread to a right-handed thread, so that in a rotary motion of the spindle 11, the upper piston 8 will rise, and the lower piston 4 will descend. The spindle 11 is designed as a rising pipe 26 and opened to the lower chamber 10 near the bottom.

The embodiment shown in FIG. 6 is similar to the embodiment shown in FIG. 2. However, a separate drive is provided for each spindle 20, 22. Reference numeral 70 designates a tappet of an inner spindle 22 which is operatively connected with the tappet 70 via a shaft 72 which penetrates the outer spindle 20. This shaft 72 bears the counter-toothing to the tappet 70 of the inner spindle 22. Reference numeral 74 designates the tappet of the outer spindle which acts on the outer spindle 20 via a spindle flange 48 in the manner described above with reference to FIG. 1. Reference numeral 76 designates the drive sleeve for driving the inner spindle 22; reference numeral 78 designates the drive sleeve for driving the outer spindle 20. The two drive sleeves 76, 78 are each integrally formed at the housing head 6 and surround the channels 56, 58. In the embodiment shown in FIG. 6, the dosing ratio can be adjusted by the type of toothing between the tappet 70; 74, and the allocated counter-toothing. As an alternative or supplement, the mixing ratio can be adjusted via the spindle pitch and/or the design of the positive fit between the drive sleeve 76, 78 and the tappet 70, 74. In FIG. 6, a unitary housing head 6 is represented. However, it is conceivable to split the housing head 6, so that one dosing element movable in the vertical direction against the force of a readjusting spring is provided for each of the two drives to optionally also act only on one drive.

FIG. 7 shows a further embodiment of a multi-chamber container with a container housing 2 and a housing head 6 as well as a drive 31 as already described above with reference to FIG. 5. In the embodiment shown in FIG. 7, too, the two pistons 4, 8 are provided directly one next to the other in the original position shown there and run in opposite directions for compressing and for discharging the product components contained in the chambers 10, 12. The drive 31 acts on the outer spindle 20. The latter has a wound spindle surface at its inner periphery which cooperates with a thread 57 of the inner spindle 22 provided correspondingly. The outer periphery of the outer spindle 20 is in contrast provided with a pitch in the opposite direction of the inner periphery of the outer spindle 20. The inner spindle 22 is connected to the lower piston 4 in a torque-proof manner. Upon actuation of the drive 31, the upper piston 8 is displaced within the container housing 2 in a translatory manner by rotation of the outer spindle 20, whereas the retained inner spindle 22 rises relative to the outer spindle 20 and thereby pushes out the lower piston 4 to the bottom. This lower piston 4 is retained by the sealing lips provided at the outer periphery of the piston to adhere to the inner periphery of the container housing 2, so that the inner spindle 22 remains in the container housing 2 in a torque-proof manner. If required, the container housing 2 and the allocated pistons 4, 8 can be formed with a not rotationally symmetric base, so that by a positive locking, a relative motion of the pistons 4 and 8, respectively, about the longitudinal axis of the container housing 2 is reliably prevented.

FIG. 8 shows a further embodiment whose drive 31 and spindles 11 essentially correspond to the embodiments described in FIG. 7. However, the thread surface provided at the outer spindle 20 is realized with the same sense of rotation at the inner periphery and at the outer periphery. In the original position shown in FIG. 8, the lower piston 4 is located at the lower end of the container housing 2. In this embodiment, too, the inner spindle 22 is retained in the container housing 2 in a torque-proof manner via the lower piston 4. Pushing the housing head 6 results in an actuation of the drive 31, such that the outer spindle 20 is rotated. The inner spindle 22 retained in a torque-proof manner accordingly rises in the outer spindle 20. The inner spindle is realized as a broadened head at a spindle rod 80, where inlet openings 82 to the rising pipe 26 are left open at the transition between the inner spindle 22 and the spindle rod 80.

FIG. 9 shows a further embodiment of the present invention with a continuous spindle 11 with an upper spindle 20 and a lower spindle 22 having different thread pitches, so that with a predetermined angular amount of the spindle 11, the upper piston 8 is translatorily moved to a smaller degree than the lower piston 4. The spindle 11 is designed as a rising pipe 26 and has inlet openings 82 at the end of the upper spindle 20 for the product component of the lower chamber 10. The spindle 11 is integrally fixed to the housing bottom 62 which is firmly connected to the container housing 2. An inner container 84 enclosing the chambers 10, 12 and accommodating the pistons 4, 8 is located in the container housing 2 so as to be rotatable. This inner container 84 cooperates with the drive 31 and comprises the annular face 46 with the counter-toothing 44. Upon actuation of the housing head 6, the inner container 84 is accordingly rotated in the container housing 2. The pistons 4, 8 resting against the inner periphery of the inner container 84 are entrained with this rotary motion, so that the pistons 4, 8 rise along the spindle 11.

FIG. 10 shows a further embodiment similar to the embodiment shown in FIG. 3. In the embodiment shown in FIG. 10, however, the drive is simplified. The spindle 11, which is essentially embodied according to the spindle of embodiment 9, is part of a housing bottom element 62 which is mounted captively though rotatably in the axial direction at the container housing 2.

FIG. 11 shows a further embodiment whose container housing 2 is similar to the container housing described with reference to FIG. 4. Especially, the container housing 2 is divided by a lower partition 68 which separates chamber 10 from chamber 12. Accordingly, the pistons 4, 8 received in the two chambers 10, 12 are each displaced against a fixed housing cover 68 or 66, respectively. The drive, however, is a different one.

In the embodiment shown in FIG. 11, the pistons 4, 8 each comprise a spring washer 86 at their ends facing away from the allocated container volume. The spring washer 86 provided at the upper piston 8 cooperates with an outer push rod 88, while the spring washer 86 allocated to the lower piston 4 cooperates with an inner push rod 90. The two push rods 88, 90 are connected to each other at the upper end of the inner push rod 90. The free end of the outer push rod 88 grips over a pipe socket 92 which is formed to the lower partition 68 and clearly projects over it in the direction of the housing head 6. Here, the outer push rod 88 grips over the pipe socket 92 in a sealing manner. Between the pipe socket 92 and the inner push rod 90, a ring channel 24 as part of the rising pipe 26 is formed in the lower region and ends in the channel 58 formed at the container housing 2. This channel 58 is surrounded by a pipe piece 94 integrally formed by the housing head 6, the pipe piece being connected on its end side with the outer push rod 88.

The spring washers 86 only cooperate with the push rods 88 in an arresting manner in one direction. If now upon actuation of the housing head 6, the latter is pressed downwards against the readjusting force of the readjusting spring 54, the push rods 88, 90 slide downwards relative to the pistons 4, 8 and past key edges of the spring washers 86. These are slightly inclined towards the bottom, so that in a readjusting motion of the push rods 88, 90 due to the readjusting spring 54, the spring washer and thus the pistons 4, 8 get interlocked at the outer periphery of the push rods 88, 90 and are engaged with them. The readjusting force of the readjusting spring 54 accordingly causes a discharge of product components from the respective chambers 10, 12 by the pistons 4, 8 moving upwards. The travel amounts of the two pistons 4, 8 are identical in this embodiment due to the coupling of the inner and outer push rods 88, 90.

FIG. 12 finally shows an embodiment similar to the one shown in FIG. 2 and with reference to this discussed embodiment. The particularity of this embodiment is the design of the housing head. The latter comprises a cap 96 locked with the container housing 2 and movable in the longitudinal direction of the container housing 2, the cap surrounding an adjusting head 98 which leaves the discharge openings 16, 18 open which are exposed at the outer side of the cap 96. The cap 96 is connected with the adjusting head 98 in a torque-proof manner, so that a rotation of the cap 96 relative to the container housing 2 takes along the adjusting head 98. By this rotary motion, the degree of overlap of the discharge openings 16, 18 formed at the adjusting head 98 with cross holes formed corresponding to them at a channel cover 100, and thus the mixing ratio of the individual product components when these are discharged, can be varied. The channel cover 100 grips over a counter-toothing sleeve 102 forming the counter-toothing 44 which is locked in the upper partition 66 in a sealing and rotating manner.

An upper locating surface for a readjusting retaining element 54 forming the readjusting spring 54 is provided within the cap. A pusher actuation of the cap 96 takes along this readjusting retaining element 104 thus compressing the readjusting spring 54. The readjusting retaining element 104 furthermore forms the drive sleeve 32 with its legs extending inside in parallel to the longitudinal axis of the container, the drive sleeve 32 being positively engaged with the tappet 38 to cause a rotary motion of the tappet 38 in an axial motion of the readjusting retaining element 104.

By the rotary motion of the tappet 38, the rising pipe 26 and the spindle 22 connected to it in a torque-proof manner are rotated, thereby lifting the lower piston 4. The product mass in the chamber 10 is thus discharged via the rising pipe 26 to such a degree as permitted by the overlap of the opening 16 and the corresponding cross hole of the channel cover 100. Correspondingly, the product mass is discharged from the chamber 12, the compressing piston 8 being shifted forward by the shifting of the product mass forward and out of the chamber 10 to a degree permitted by the overlap of the corresponding opening 18 and the cross hole of the channel cover 100. If the two said openings are not overlapping, no product will be discharged from the respective allocated chamber 10, 12 at all, and the complete product quantity is discharged from the respective other chamber.

The embodiment described above by way of example permits to provide on the one hand a special drive in the sense of the present invention which converts an axial motion of the housing head 6 into a rotary motion of the spindle 11. Moreover, the design permits a variation of the mixing ratio of the discharged substances from the respective chamber 10.

### LIST OF REFERENCE NUMERALS

2 Container housing

4 Lower piston

6 Housing head

8 Upper piston

10 Lower chamber

11 Spindle

12 Upper chamber

14 Dosing element

16 Discharge opening

18 Discharge opening

20 Outer spindle/upper spindle

22 Inner spindle/lower spindle

24 Ring channel

26 Rising pipe

28 Self-cutting element

30 Self-cutting element

31 Drive

32 Drive sleeve

34 Guide bevel

36 Tappet cam

38 Tappet

40 Tappet flange

42 Toothing

44 Counter-toothing

46 Annular face

48 Spindle flange

50 Axial projection

51 Additional counter-toothing

52 Pressure spring/drive

54 Readjusting spring/housing head

5 Thread

56 Channel

57 Thread

58 Channel

60 Housing element

62 Housing bottom

64 Ring disk

66 Upper partition

68 Lower partition

70 Tappet of the inner spindle

72 Shaft

74 Tappet of the outer spindle

76 Drive sleeve of the inner spindle

78 Drive sleeve of the outer spindle

80 Spindle rod

82 Inlet opening

84 Inner container

86 Spring washer

88 Outer push rod

90 Inner push rod

92 Pipe socket

94 Pipe piece

96 Cap

98 Adjusting head

100 Channel cover

102 Counter-toothing sleeve

104 Readjusting retaining element

1-27. (canceled)

28. A multi-chamber container comprising a container housing with at least two chambers arranged one upon the other for receiving product components, and a dosing element which discharges the product components by means of pistons allocated to the chambers and displaceable in the longitudinal axis of the container, wherein
at least one piston is movably engaged with an element extending in the longitudinal axis of the container.

29. The multi-chamber container according to claim 28, wherein the chambers are separated by a housing partition.

30. The multi-chamber container according to claim 28, wherein at least two pistons perform motions in opposite directions along the longitudinal axis of the container.

31. The multi-chamber container according to claim 28, further comprising at least one positive-fit element of metal and wherein the at least one positive-fit element is fixed by injection molding around with plastics.

32. A multi-chamber container comprising a container housing with at least two chambers arranged one upon the other for receiving product components, and a dosing element which discharges the product components by means of pistons allocated to the chambers and displaceable in the longitudinal axis of the container, wherein at least one piston is movably engaged with an element extending in the longitudinal axis of the container.

33. The multi-chamber container according to claim 32, wherein the element is a push rod displaceable along the longitudinal axis of the container.

34. The multi-chamber container according to claim 33, wherein the push rod comprises an outer push rod and at least one inner push rod.

35. The multi-chamber container according to claim 34, wherein the outer push rod and the at least one inner push rod are stationarily connected to each other.

36. The multi-chamber container according to claim 33, wherein at least the outer push rod is embodied as a rising pipe.

37. The multi-chamber container according to claim 32, wherein the engagement is a self-cutting, positive engagement.

38. A multi-chamber container comprising a container housing with at least two chambers arranged one upon the other for receiving product components, and a dosing element which discharges the product components by means of pistons allocated to the chambers and displaceable in the longitudinal axis of the container, wherein at least one piston is movably engaged with an element extending in the longitudinal axis of the container and wherein at least one piston forms an engagement region and that the element is a spindle.

39. The multi-chamber container according to claim 38, further comprising an inner container rotatably mounted in the container housing which forms the chambers, and wherein the at least one spindle is fixed in the container housing in a torque-proof manner.

40. The multi-chamber container according to claim 39, wherein the inner container is made of metal.

41. The multi-chamber container according to claim 38, further comprising a drive with a drive sleeve which drives a tappet via a guide bevel which comprises a toothing embodied concentrically to the spindle axis, which cooperates with a counter-toothing acting on the spindle.

42. The multi-chamber container according to claim 38, wherein the spindle comprises an outer spindle and at least one inner spindle.

43. The multi-chamber container according to claim 38, wherein the spindle comprises an upper spindle and at least one lower spindle.

44. The multi-chamber container according to claim 41, wherein at least two spindles are provided to which one drive each is allocated.

45. The multi-chamber container according to claim 42, wherein the outer spindle is connected with the at least one inner spindle, or the upper spindle is connected with the at least one lower spindle, respectively, in a torque-proof manner.

46. The multi-chamber container according to claim 38, wherein at least one spindle is embodied as a rising pipe.

47. The multi-chamber container according to claim 38, wherein an outer thread is formed at the spindle which is rotatably engaged with a piston.

48. The multi-chamber container according to claim 47, wherein the outer spindle is rotatably engaged with at least one inner spindle via a thread.

49. The multi-chamber container according to claim 47, wherein at least one of the engaged threads has a different pitch.

50. The multi-chamber container according to claim 48, wherein the engagement region receives the spindle which is rotatably engaged with the outer spindle in a torque-proof manner.
